(19) United States
(12) Patent Application Publication
(10) Pub. No.: US 2025/0327569 A1
(43) Pub. Date: Oct. 23, 2025

(54) CHEMICAL LOOP REACTION SYSTEM

(71) Applicant: TOKYO OHKA KOGYO CO., LTD., Kanagawa (JP)

(72) Inventor: Hirotsugu KUMAZAWA, Kanagawa (JP)

(21) Appl. No.: 18/868,389

(22) PCT Filed: May 16, 2023
(86) PCT No.: PCT/JP2023/018251

§ 371 Date: Nov. 22, 2024

(30) Foreign Application Priority Data
Jun. 3, 2022 (JP) 2022-090952

(51) Int. Cl. F23C 10/04; F23C 10/26; F23C 10/28; F23K 5/22

(52) U.S. Cl. CPC F23C 10/04; F23C 10/26; F23C 10/28; F23K 5/22; F23C 2206/10; F23C 2900/99008

(57) ABSTRACT

To improve operational efficiency by effectively utilizing produced carbon dioxide in a chemical loop reaction system, a chemical loop reaction system 100 includes an oxidation column 10 to oxidize metal particles M into metal oxide particles MO, a reduction column 20 to react the metal oxide particles MO with a reducing agent R to reduce the metal oxide particle MO into the metal particles M while producing carbon dioxide, and a circulator 60 that circulates the metal particles M and the metal oxide particles MO between the reduction column 20 and the oxidation column 10 and includes a carbon dioxide supply line 70 that supplies the carbon dioxide produced in the reduction column 20 to at least one of the reduction column 20 and the oxidation column 10.

### TECHNICAL FIELD

The present invention relates to a chemical loop reaction system and a method for utilizing carbon dioxide.

### BACKGROUND ART

Conventionally, a chemical loop reaction system is known including an oxidation column to oxidize metal particles into metal oxide particles, a reduction column to react the metal oxide particles with a reducing agent to reduce the metal oxide particles into the metal particles while producing carbon dioxide, and a circulator that circulates the metal particles and the metal oxide particles between the reduction column and the oxidation column (refer to Patent Literature 1, for example).

### CITATION LIST

### Patent Literature

[Patent Literature 1] Japanese Unexamined Patent Application Publication No. 2018-155437

### SUMMARY OF INVENTION

### Technical Problem

In the system described in Patent Literature 1, when the metal oxide particles are reduced by the reducing agent in the reduction column, the carbon dioxide is produced.

The carbon dioxide is required to be processed in order to avoid most of the produced carbon dioxide from being released into the atmosphere, which causes an increase in the operating costs of the chemical loop reaction system. Thus, to improve the operational efficiency of the system, the produced carbon dioxide is required to be effectively utilized.

An object of the present invention is to provide a chemical loop reaction system and a method for utilizing carbon dioxide that can improve operational efficiency by utilizing produced carbon dioxide inside the chemical loop reaction system.

### Solution to Problem

A chemical loop reaction system according to an aspect of the present invention is a chemical loop reaction system including an oxidation column to oxidize metal particles into metal oxide particles, a reduction column to react the metal oxide particles with a reducing agent to reduce the metal oxide particle into the metal particles while producing carbon dioxide, and a circulator that circulates the metal particles and the metal oxide particles between the reduction column and the oxidation column and including a carbon dioxide supply line that supplies the carbon dioxide produced in the reduction column to at least one of the reduction column and the oxidation column.

A method for utilizing carbon dioxide according to an aspect of the present invention is a method for utilizing carbon dioxide produced, in a chemical loop reaction system including an oxidation column to oxidize metal particles into metal oxide particles, a reduction column to react the metal oxide particles with a reducing agent to reduce the metal oxide particles into the metal particles while producing carbon dioxide, and a circulator that circulates the metal particles and the metal oxide particles between the reduction column and the oxidation column, in the reduction column and includes supplying the carbon dioxide produced in the reduction column to at least one of the reduction column and the oxidation column to fluidize the metal particles and the metal oxide particles.

### Advantageous Effects of Invention

According to the above aspects, the produced carbon dioxide is supplied to at least one of the reduction column and the oxidation column to replace part or the whole of the gas to be supplied to the reduction column or the oxidation column with the carbon dioxide, and thus the flow of the gas that should be supplied to the reduction column or the oxidation column can be reduced, and thus operational efficiency can be improved in the chemical loop reaction system. In addition, the produced carbon dioxide is utilized in the chemical loop reaction system, and thus the carbon dioxide can be used effectively, and the amount of the carbon dioxide to be released into the atmosphere can be reduced.

### BRIEF DESCRIPTION OF THE DRAWINGS

FIG. 1 is a diagram of an example of a chemical loop reaction system according to a first embodiment.

FIG. 2 is a diagram of an example of an oxidation column and a reduction column.

FIG. 3 is an enlarged view of a state in which metal oxide particles enter the reduction column.

FIG. 4 is a diagram of an example of a solid-gas separation apparatus connected to the reduction column.

FIG. 5 is a flowchart of an example of a method for utilizing carbon dioxide according to the first embodiment.

FIG. 6 is a flowchart of the example of the method for utilizing carbon dioxide according to the first embodiment following FIG. 5.

FIG. 7 is a flowchart illustrating part of the flowchart in FIG. 6 in detail.

FIG. 8 is a diagram of an example of a chemical loop reaction system according to a second embodiment.

FIG. 9 is a flowchart of an example of a method for utilizing carbon dioxide according to the second embodiment.

FIG. 10 is a diagram of an example of a chemical loop reaction system according to a third embodiment.

FIG. 11 is a flowchart of an example of a method for utilizing carbon dioxide according to the third embodiment.

FIG. 12 is a diagram of an example of a chemical loop reaction system according to a fourth embodiment.

FIG. 13 is a flowchart of an example of a method for utilizing carbon dioxide according to the fourth embodiment.

FIG. 14 is a diagram of an example of a chemical loop reaction system according to a fifth embodiment.

FIG. 15 is a diagram of an example of a chemical loop reaction system according to a sixth embodiment.

### DESCRIPTION OF EMBODIMENTS

The following describes embodiments of the present invention with reference to the accompanying drawings. However, the present invention is not limited to the details described below. The drawings are represented with the scale changed as appropriate, including illustrating some parts in an enlarged or highlighted manner, in order to illustrate the embodiments and may differ from actual products in shape, dimensions, and the like.

### First Embodiment

### Chemical Loop Reaction System

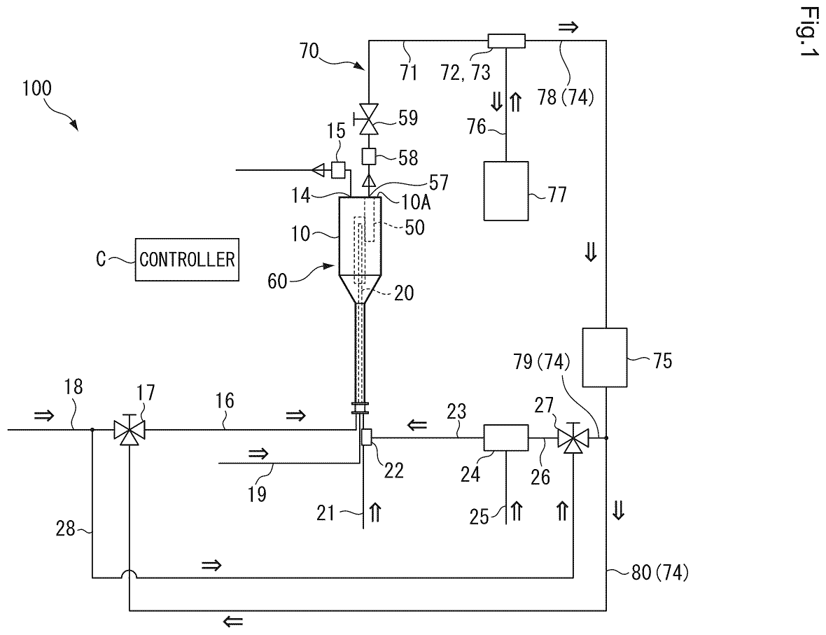

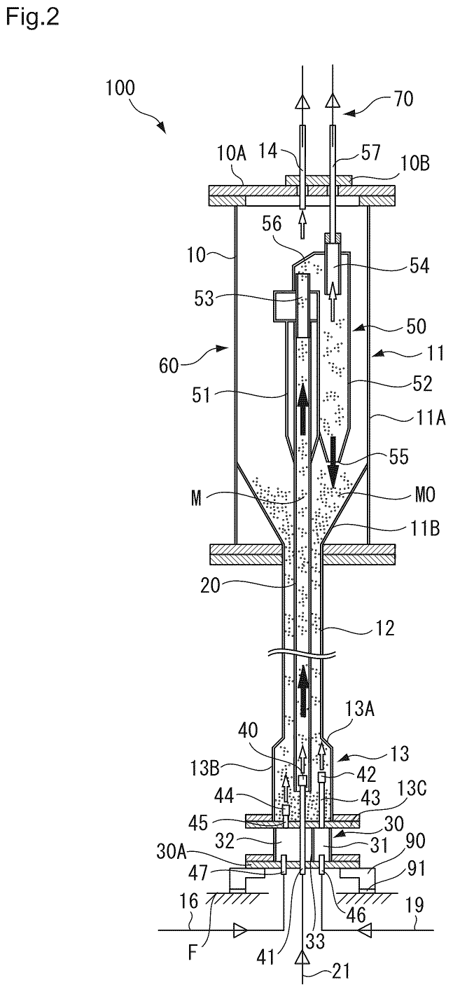

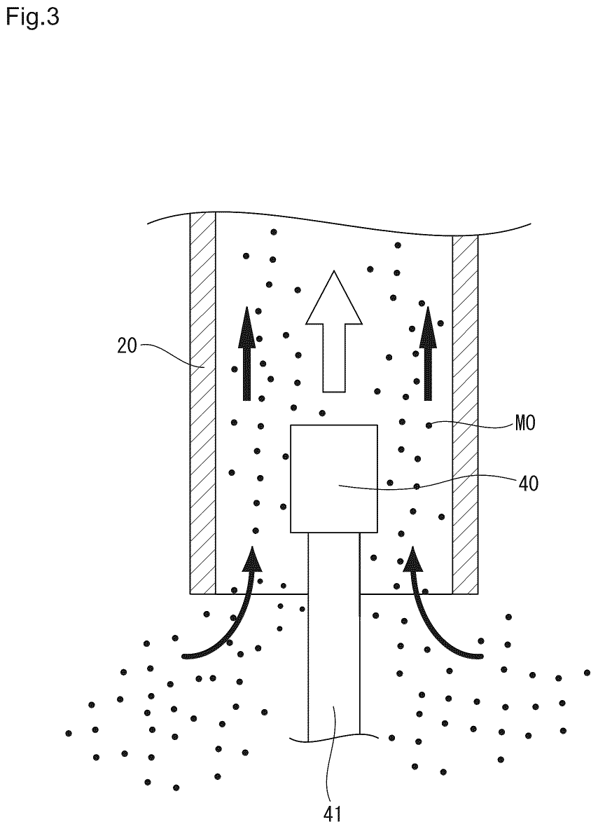

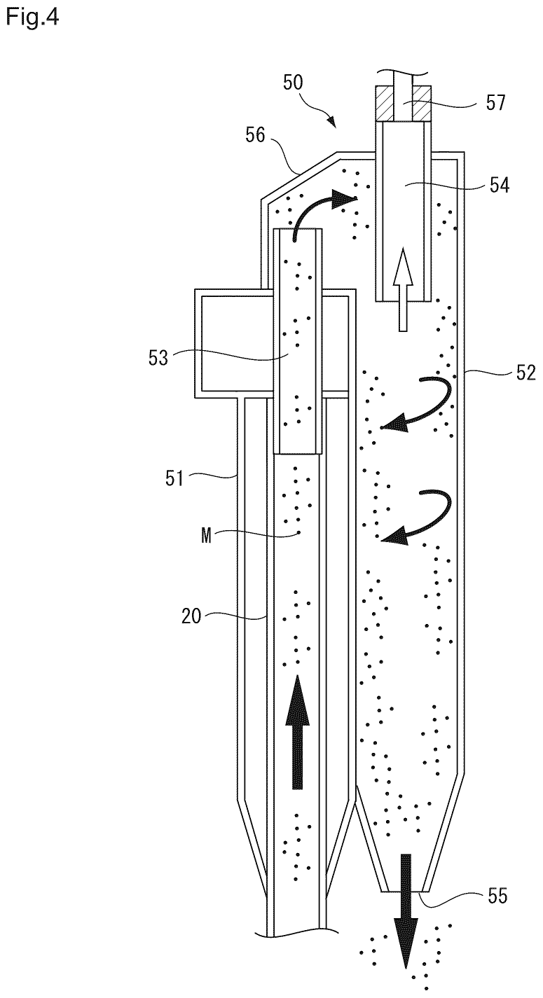

FIG. 1 is a diagram of an example of a chemical loop reaction system 100 according to a first embodiment. FIG. 2 is a diagram of an example of an oxidation column 10 and a reduction column 20 in the chemical loop reaction system 100. FIG. 3 is an enlarged view of a state in which metal oxide particles MO enter the reduction column 20. FIG. 4 is a diagram of an example of a solid-gas separation apparatus 50 connected to the reduction column 20. In the chemical loop reaction system 100, housed metal particles M are oxidized into the metal oxide particles MO and the metal oxide particles MO are reduced into the metal particles M by a reducing agent, whereby processing with the reducing agent is performed. Note that the details of the metal particles M will be described below.

As illustrated in FIG. 1 and FIG. 2, the chemical loop reaction system 100 includes the oxidation column 10, the reduction column 20, an air supply line 19, a fuel supply line 21 (a reducing agent supply line), a vapor supply line 23, a fluidizing gas supply line 16, a nitrogen supply line 18, a circulator 60, a carbon dioxide supply line 70, and a controller C. The oxidation column 10 houses the metal particles M. Note that the details of the metal particles M will be described below. In the oxidation column 10, the metal particles M are oxidized into the metal oxide particles MO. As illustrated in FIG. 2, the oxidation column 10 is a cylindrical outer column made of a heat-resistant material such as a steel plate. An upper end of the oxidation column 10 is closed by a top plate 10A. The oxidation column 10 includes an upper part 11, a central part 12, a lower part 13, and an exhauster 14.

The upper part 11 has a cylindrical upper-side part 11A extending in an up and down direction and a diameter-reducing part 11B reducing in diameter downward from a lower end of the upper-side part 11A. The central part 12 is formed in a cylindrical shape connected to a lower end of the diameter-reducing part 11B and extending downward. The lower part 13 is connected to a lower end of the central part 12 and has a diameter-expanding part 13A expanding in diameter downward and a cylindrical lower-side part 13B extending downward from a lower end of the diameter-expanding part 13A. A lower end of the lower part 13 is closed by a first bottom plate 13C. Note that the diameter of the central part 12 is smaller than the diameter of the lower-side part 13B of the lower part 13 and the diameter of the upper part 11A of the upper part 11. The diameter of the lower-side part 13B of the lower part 13 is smaller than the diameter of the upper-side part 11A of the upper part 11.

The lower part 13 includes an air nozzle 42, an air supply pipe 43, a fluidizing gas nozzle 44, and a fluidizing gas supply pipe 45. The air nozzle 42 ejects air upward and supplies the air to the oxidation column 10. The air nozzle 42 is disposed above a lower end of the reduction column 20. This form can inhibit the air ejected from the air nozzle 42 from entering the reduction column 20. The air supply pipe 43 is provided passing through the first bottom plate 13C and holds the air nozzle 42 at its upper end. The air supply pipe 43 is set to have a length causing the air nozzle 42 to be disposed above the lower end of the reduction column 20. The air supply pipe 43 connects an air chamber 31, which will be described below, and the air nozzle 42 to each other and sends air in the air chamber 31 to the air nozzle 42. Note that a height adjuster enabling the height of the air nozzle 42 to be changed by adjusting the length of the air supply pipe 43 may be provided, for example.

The fluidizing gas nozzle 44 ejects a fluidizing gas upward and supplies the fluidizing gas to the oxidation column 10. Note that examples of the fluidizing gas include nitrogen. The fluidizing gas nozzle 44 is disposed below the lower end of the reduction column 20. With this form, by ejecting the fluidizing gas from the fluidizing gas nozzle 44, the fluidizing gas can be supplied to the oxidation column 10, and the metal particles M and the metal oxide particles MO can be fluidized in the oxidation column 10.

The fluidizing gas supply pipe 45 is provided passing through the first bottom plate 13C and holds the fluidizing gas nozzle 44 at its upper end. The fluidizing gas supply pipe 45 is set to a length causing the fluidizing gas nozzle 44 to be disposed below the lower end of the reduction column 20. The fluidizing gas supply pipe 45 connects a fluidizing gas chamber 32, which will be described below, and the fluidizing gas nozzle 44 to each other and sends the fluidizing gas in the fluidizing gas chamber 32 to the fluidizing gas nozzle 44. Note that a height adjuster enabling the height of the fluidizing gas nozzle 44 to be changed by adjusting the length of the fluidizing gas supply pipe 45 may be provided, for example.

Below the lower part 13 of the oxidation column 10, the air chamber 31 and the fluidizing gas chamber 32 are provided. A cylindrical part 30 is provided, the upper end of which is closed by the first bottom plate 13C and the lower end of which is closed by a second bottom plate 30A. The inside of this cylindrical part 30 is partitioned by a partition plate 33 to form the air chamber 31 and the fluidizing gas chamber 32. The cylindrical part 30 is provided with the same inner diameter as the lower part 13. The air chamber 31 communicates with the lower part 13 via the air supply pipe 43 and the air nozzle 42. The fluidizing gas chamber 32 communicates with the lower part 13 via the fluidizing gas supply pipe 45 and the fluidizing gas nozzle 44.

The air chamber 31 includes an air introducer 46. The air introducer 46 is provided passing through the second bottom plate 30A and is connected to the air supply line 19. The air chamber 31 stores air sent via the air supply line 19 and the air introducer 46. The air chamber 31 increases in pressure through the air sent from the air supply line 19. When the air chamber 31 increases in pressure, the air in the air chamber 31 is ejected into the oxidation column 10 from the air nozzle 42 via the air supply pipe 43. The air ejected into the oxidation column 10 functions as an oxidant in the oxidation column 10.

The fluidizing gas chamber 32 includes a fluidizing gas introducer 47. The fluidizing gas introducer 47 is provided passing through the second bottom plate 30A and is connected to the fluidizing gas supply line 16. The fluidizing gas chamber 32 stores the fluidizing gas sent via the fluidizing gas supply line 16 and the fluidizing gas introducer 47. The fluidizing gas chamber 32 increases in pressure through the fluidizing gas sent from the fluidizing gas supply line 16. When the fluidizing gas chamber 32 increases in pressure, the fluidizing gas in the fluidizing gas chamber 32 is ejected into the oxidation column 10 from the fluidizing gas nozzle 44 via the fluidizing gas supply pipe 45. The fluidizing gas ejected into the oxidation column 10 fluidizes the metal oxide particles MO present in the oxidation column 10. Part of the fluidizing gas ejected into the oxidation column 10 enters the reduction column 20 and fluidizes the metal particles M or the metal oxide particles MO inside the reduction column 20.

The exhauster 14 is disposed passing through a fixer 10B provided on the top plate 10A at an upper end of the oxidation column 10. The gas inside the oxidation column 10 is discharged from the oxidation column 10 via the exhauster 14. In the exhauster 14, a solid-gas separator 15 is provided. The solid-gas separator 15 separates a solid component and gas contained in the gas discharged from the exhauster 14 from each other. For the solid-gas separator 15, for example, a filter, a cyclone apparatus, or the like is used. The gas discharged from the exhauster 14 is mainly nitrogen with a small amount of oxygen contained, as will be described later. The gas discharged from the exhauster 14 is released into the atmosphere or reused as the fluidizing gas after the solid component is removed in the solid-gas separator 15.

The reduction column 20 is disposed inside the oxidation column 10. The reduction column 20 is a cylindrical inner column made of a heat-resistant material such as a steel plate with an outer diameter smaller than the inner diameter of the oxidation column 10. In the reduction column 20, the metal oxide particles MO are reacted with a reducing agent to reduce the metal oxide particles MO into the metal particles M while carbon dioxide is produced. The reduction column 20 is disposed inside the oxidation column 10 with their central axes in the up and down direction matched. The reduction column 20 is formed to have a length spanning the upper part 11, the central part 12, and the lower part 13 of the oxidation column 10 in the up and down direction. In the present embodiment, one reduction column 20 is disposed inside the oxidation column 10, but this form is not limiting, and a plurality of reduction columns 20 may be disposed inside the oxidation column 10. The oxidation column 10 and the reduction column 20 may be disposed separated from each other.

The reduction column 20 includes a fuel nozzle 40, a fuel supply pipe 41, and a solid-gas separation apparatus 50. The fuel nozzle 40 is disposed at a position slightly above the lower end of the reduction column 20, and inserted into the reduction column 20. The fuel nozzle 40 ejects fuel (the reducing agent), water vapor, and a carrier gas upward. This configuration inhibits the fuel and the like ejected from the fuel nozzle 40 from being supplied to the outside of the reduction column 20. The fuel (the reducing agent), the water vapor, and the carrier gas will be described below. The outer diameter of the fuel nozzle 40 is smaller than the inner diameter of the reduction column 20, and a gap enabling the metal oxide particles MO to pass through is formed between the fuel nozzle 40 and the reduction column 20.

The fuel supply pipe 41 holds the fuel nozzle 40 at its upper part. The fuel supply pipe 41 is provided passing through the first bottom plate 13C, the fluidizing gas chamber 32, and the second bottom plate 30A and is connected to the fuel supply line 21 at its lower part. The length of the fuel supply pipe 41 is set to the length inserting the fuel nozzle 40 into the reduction column 20. Note that a height adjuster enabling the height of the fuel nozzle 40 to be changed by adjusting the length of the fuel supply pipe 41 may be provided, for example. The fuel and the like are ejected into the reduction column 20 from the fuel nozzle 40 via the fuel supply pipe 41 from the fuel supply line 21.

As illustrated in FIG. 3, the fuel nozzle 40 ejects the fuel and the like upward. Consequently, as shown by the white arrow, an upward flow is formed in the reduction column 20 to take in the metal oxide particles MO from an opening at the lower end of the reduction column 20 and raise them. As described above, the gap is formed between the fuel nozzle 40 and the reduction column 20, and the metal oxide particles MO rise in the reduction column 20 through this gap and are reduced by the fuel ejected from the fuel nozzle 40 during their rising inside the reduction column 20 to become the metal particles M.

The solid-gas separation apparatus 50 is connected via a connection pipe 53 provided at an upper part of the reduction column 20. In the present embodiment, the solid-gas separation apparatus 50 is connected to a protection tube 51 provided outside the reduction column 20 and is provided in parallel with the reduction column 20. For the solid-gas separation apparatus 50, for example, a cyclone is used separating into a solid component and a gas component by generating a swirling flow inside. The solid component is the metal particles M and the metal oxide particles MO that have not been reduced in the reduction column 20.

The solid-gas separation apparatus 50 returns the separated solid component to the oxidation column 10. An exhaust pipe 54 is provided at an upper part of the solid-gas separation apparatus 50. The separated gas component is discharged from the exhaust pipe 54. The gas component is mainly carbon dioxide and may contain water vapor. The exhaust pipe 54 is connected to an exhauster 57. The exhauster 57 is provided passing through the fixer 10B provided on the top plate 10A. The exhauster 57 is provided with a gas-liquid separation apparatus 58 (refer to FIG. 1). The gas-liquid separation apparatus 58 separates a liquid component (for example, water vapor) contained in the gas component discharged from the exhauster 57.

As illustrated in FIG. 4, the solid-gas separation apparatus 50 generates a swirling flow in a cylindrical body 52 by guiding the flow discharged upward from the connection pipe 53 by an introducer 56. The swirling flow continues to swirl while moving downward in the body 52. In this swirling flow, the solid component moves downward while swirling near an inner wall of the body 52 and is discharged into the oxidation column 10 from a diameter-reducing opening 55 at a lower part of the body 52. The gas component, on the other hand, flows upward at a central part of the swirling flow and is discharged by the exhauster 57 via the exhaust pipe 54. That is, the solid-gas separation apparatus 50 returns the metal particles M and the like to the oxidation column 10 and discharges carbon dioxide from the solid-gas mixed flow discharged from the reduction column 20.

The circulator 60 circulates the metal particles M and the metal oxide particles MO between the reduction column 20 and the oxidation column 10. The metal particles M filled in the oxidation column 10 are oxidized to become the metal oxide particles MO, which are in a state flowing in the lower part 13 of the oxidation column 10. In the reduction column 20, owing to the flow of the fuel ejected from the air nozzle 42, the metal oxide particles MO enter the reduction column 20, in which they become the metal particles M, and then the metal particles M are returned to the oxidation column 10 by the solid-gas separation apparatus 50. The circulator 60 causes such circulation of the metal particles M and the metal oxide particles MO between the reduction column 20 and the oxidation column 10 to be executed.

Referring back to FIG. 1, the air supply line 19 supplies air to the air chamber 31. One end of the air supply line 19 is connected to an air supplier, not illustrated, and the other end thereof is connected to the air introducer 46. The air supplier includes, for example, a tank to store air and a pump to send air. The air supply line 19 sends air from the air supplier to the air introducer 46. The air supply line 19 may include, for example, a flow meter, a pressure regulator valve, and the like. By operating the flow meter, the pressure regulating valve, and the like, the air supply line 19 can send a preset flow of air to the air introducer 46.

The fuel supply line 21 supplies an organic solvent as the fuel (the reducing agent) mixed with vapor to the fuel nozzle 40. The organic solvent functions as the reducing agent in the reduction column 20. The organic solvent contains a powdery or granular resin. The fuel supply line 21 is connected to a fuel supplier, not illustrated. The fuel supplier includes, for example, a tank to store fuel, a liquid sending pump, and the like. The fuel supply line 21 has a mixer 22. The vapor supply line 23 is connected to the mixer 22. The mixer 22 mixes the organic solvent sent by fuel supply line 21 and vapor sent by the vapor supply line 23 at a preset certain ratio.

The vapor supply line 23 includes a vapor generation unit 24 and supplies vapor generated by the vapor generation unit 24 to the mixer 22. The vapor generation unit 24 includes a heat source, not illustrated, and heats water supplied from a water supply line 25 to generate vapor. The water supply line 25 is connected to a water supplier, not illustrated. The water supplier includes, for example, a water storage tank, a water sending pump, and the like.

A carrier gas supply line 26 is connected to the vapor generation unit 24. The carrier gas supply line 26 supplies the carrier gas to the vapor generation unit 24. The carrier gas is used to carry the vapor generated in the vapor generation unit 24 to the vapor supply line 23. The carrier gas supply line 26 is connected to a second nitrogen supply line 28, which will be described below, and a second connection line 79, which is part of a first line 74 out of the carbon dioxide supply line 70, which will be described below, via a first switching valve 27.

The first switching valve 27 is controlled by the controller C to switch the connection destination of the carrier gas supply line 26. The first switching valve 27 is connected to the carrier gas supply line 26, the second nitrogen supply line 28, and the second connection line 79. The first switching valve 27 switches the connection destination of the carrier gas supply line 26 between the second nitrogen supply line 28 and the second connection line 79. When the carrier gas supply line 26 is connected to the second nitrogen supply line 28 by the first switching valve 27, nitrogen is supplied to the vapor generation unit 24 as the carrier gas. When the carrier gas supply line 26 is connected to the second connection line 79 by the first switching valve 27, carbon dioxide is supplied to the vapor generation unit 24 as the carrier gas.

The fluidizing gas supply line 16 supplies the fluidizing gas to the fluidizing gas chamber 32. One end of the fluidizing gas supply line 16 is connected to a second switching valve 17 and the other end thereof is connected to the fluidizing gas introducer 47. The second switching valve 17 is controlled by the controller C to switch the connection destination of the fluidizing gas supply line 16. The second switching valve 17 is connected to the fluidizing gas supply line 16, the nitrogen supply line 18, and a third connection line 80, which is part of the first line 74 out of the carbon dioxide supply line 70.

The second switching valve 17 switches the connection destination of the fluidizing gas supply line 16 between the nitrogen supply line 18 and the third connection line 80. When the fluidizing gas supply line 16 is connected to the nitrogen supply line 18 by the second switching valve 17, nitrogen is supplied to the fluidizing gas chamber 32 as the carrier gas. When the fluidizing gas supply line 16 is connected to the third connection line 80 by the second switching valve 17, carbon dioxide is supplied to the fluidizing gas chamber 32 as the fluidizing gas.

The nitrogen supply line 18 is connected to a nitrogen supplier, not illustrated. The nitrogen supplier includes, for example, a tank to store nitrogen, a pump, and the like. The nitrogen supply line 18 may be, for example, connected to a nitrogen supply system provided in a building such as a factory and shared by other apparatuses. The nitrogen supply line 18 branches off upstream of the second switching valve 17 to form the second nitrogen supply line 28. Thus, the nitrogen flowing through the nitrogen supply line 18 is divided into a flow toward the second switching valve 17 and a flow toward the first switching valve 27 by the second nitrogen supply line 28.

The carbon dioxide supply line 70 supplies the carbon dioxide produced in the reduction column 20 to at least one of the reduction column 20 and the oxidation column 10. The carbon dioxide supply line 70 is connected downstream of the gas-liquid separation apparatus 58 via an opening and closing valve 59. The opening and closing valve 59 is controlled by the controller C and can regulate the flow of the carbon dioxide flowing from the reduction column 20 to the carbon dioxide supply line 70. The carbon dioxide supply line 70 has a recovery line 71, a flow measurement device 72, a regulating valve 73, the first line 74, a first tank 75, a second line 76, and a second tank 77.

The recovery line 71 connects between the opening and closing valve 59 and the flow measurement device 72 (the regulating valve 73). The flow measurement device 72 measures the flow of the carbon dioxide flowing through the recovery line 71 per unit time. The regulating valve 73 is provided in the recovery line 71 and is connected to the recovery line 71, the first line 74, and the second line 76. In the illustration, a form is described as an example in which the flow measurement device 72 and the regulating valve 73 are implemented as a single apparatus, but this form is not limiting. For example, the regulating valve 73 may be provided downstream of the flow measurement device 72 in the recovery line 71. The regulating valve 73 switches to any of a first mode causing the recovery line 71 and the first line 74 to communicate with each other, a second mode causing the recovery line 71 and the second line 76 to communicate with each other, and a third mode causing the first line 74 and the second line 76 to communicate with each other.

The regulating valve 73 may execute the first mode and the second mode described above simultaneously. That is, the regulating valve 73 may include a mode sending the carbon dioxide in the recovery line 71 to both the first line 74 and the second line 76. When the regulating valve 73 is set to the third mode, the carbon dioxide stored in the first tank 75 can be carried to the first line 74 from the second line 76 via the regulating valve 73.

The first line 74 is provided downstream of the regulating valve 73. The first line 74 includes a first connection line 78, the second connection line 79, and the third connection line 80. The first connection line 78 connects between the regulating valve 73 and the first tank 75. The first tank 75 stores carbon dioxide sent by the first connection line 78. The first tank 75 functions as a buffer to temporarily store the carbon dioxide flowing through the first line 74. Note that whether the first tank 75 is provided is optional, and the first tank 75 is not necessarily provided. The second connection line 79 connects between the first tank 75 and the first switching valve 27 described above. The third connection line 80 branches off from the second connection line 79 and is connected to the second switching valve 17. In other words, the third connection line 80 connects between the first tank 75 and the second switching valve 17 described above.

The second line 76 is provided separately from the first line 74 and connects between the regulating valve 73 and the second tank 77. The second tank 77 stores carbon dioxide sent from the second line 76 when the regulating valve 73 is in the second mode. When the flow of the carbon dioxide flowing through the recovery line 71 does not reach a desired flow by the flow measurement device 72, the second tank 77 can send the carbon dioxide to the first line 74 via the second line 76 by the regulating valve 73 becoming the second mode. Whether the second line 76 and the second tank 77 are provided is optional, and the second line 76 and the second tank 77 are not necessarily provided.

As illustrated in FIG. 2, the oxidation column 10 and the reduction column 20 are installed on a floor F via a base 90. A load cell 91 is disposed between the base 90 and the floor F. The output of the load cell 91 is input to the controller C. The load cell 91 outputs the load of the oxidation column 10 and the reduction column 20 as well as the metal particles M and the metal oxide particles MO. The controller C can measure the amount of the metal particles M and the metal oxide particles MO on the basis of the output from the load cell 91.

The metal particles M and the metal oxide particles MO may be damaged when circulating between the oxidation column 10 and the reduction column 20 in the circulator 60. The damaged fragments may be discharged from the oxidation column 10 together with the gas component in the solid-gas separation apparatus 50 described above. Consequently, the load of the metal particles M and the metal oxide particles MO is reduced by the amount discharged from the oxidation column 10. On the basis of the output from the load cell 91, the controller C may calculate how much the weight of the oxidation column 10 and the reduction column 20 (including the weight of the metal particles M and the metal oxide particles MO) has decreased since the beginning of operation when the metal particles M were housed and determine whether the metal particles M should be replenished. That is, if the reduced weight exceeds a preset threshold, it may be determined that the metal particles M and the metal oxide particles MO are insufficient, and replenishment of the metal particles M may be displayed by a display apparatus or the like. In this case, the controller C may calculate the amount of the metal particles M to be replenished from the decrease in weight and display the replenishment amount on the display apparatus or the like.

The following describes the operation of the chemical loop reaction system 100 described above. Prior to this operation, the oxidation column 10 is filled with the metal particles M. Examples of the metal particles M include iron, iron oxide (FeO, Fe₂O₃, and Fe₃O₄), and ilmenite (FeTiO₃). At the time of filling, not only the metal particles M but also the metal oxide particles MO may be contained, which are filled in the oxidation column 10.

The amount of the metal particles M filled is set to a range enabling the metal particles M (or the metal oxide particles MO) to fluidize inside the oxidation column 10 by the fluidizing gas ejected into the oxidation column 10 from the fluidizing gas nozzle 44 and the metal particles M to be circulated by the circulator 60. When the amount of the metal particles M is small, the amount of the carbon dioxide produced in the reduction column 20 is reduced, which is not preferred. Thus, the amount of the metal particles M filled is set to a range enabling the reduction column 20 to sufficiently produce the carbon dioxide.

After the metal particles M are filled, the metal particles M are preheated up to, for example, about 600° C. by preheating means such as a preheating burner, not illustrated, disposed inside the oxidation column 10 (for example, the central part 12 in particular) or an electric heater, not illustrated, mounted on a peripheral wall of the oxidation column 10 (for example, the central part 12 in particular). After the preheating or during the preheating, a certain amount of air is supplied to the air chamber 31 from the air supply line 19 via the air introducer 46. The air supplied to the air chamber 31 is ejected into the oxidation column 10 from the air nozzle 42. The air ejected into the oxidation column 10 functions as an oxidant and oxidizes the metal particles M into the metal oxide particles MO.

A mixture of the organic solvent as the fuel and the vapor is ejected to the fuel nozzle 40 from the fuel supply line 21, and this mixture is supplied to the reduction column 20. The organic solvent used in the present embodiment is not limited to a particular organic solvent, and, for example, organic solvents used in organic synthesis of paints, plastics, and the like and chemicals in general can be used. Examples of them include various chemical solutions used when semiconductor elements or liquid crystal display elements are manufactured by the techniques of photolithography, DSA lithography, and imprint lithography. The organic solvent may contain resins or the like.

Examples of the chemical solutions include ones containing polar solvents such as ketone-based solvents, ester-based solvents, alcohol-based solvents, ether-based solvents, and amide-based solvents; hydrocarbon-based solvents, and the like. Examples of the chemical solutions containing resins include resin solutions produced by separation and purification during organic synthesis of resins, resin solutions in which resin components for resists are dissolved in organic solvent components as chemical solutions for lithography containing resins, resist compositions, insulating film compositions, antireflection film compositions, block copolymer compositions used for the directed self-assembly (DSA) technique, and resin compositions for imprinting. In addition, examples of chemical solutions for lithography for use in patterning or the like include pre-wetting solvents, solvents for resists, and developing solutions.

Examples of the ketone-based solvents include 1-octanone, 2-octanone, 1-nonanone, 2-nonanone, acetone, 2-heptanone (methyl amyl ketone), 4-heptanone, 1-hexanone, 2-hexanone, diisobutyl ketone, cyclohexanone, methyl cyclohexanone, phenylacetone, methyl ethyl ketone, methyl isobutyl ketone, acetylacetone, acetonylacetone, ionone, diacetone alcohol, acetylcarbinol, acetophenone, methyl naphthyl ketone, isophorone, and propylene carbonate.

Examples of the ester-based solvents include methyl acetate, butyl acetate, ethyl acetate, isopropyl acetate, pentyl acetate, isopentyl acetate, amyl acetate, propylene glycol monomethyl ether acetate, ethylene glycol monoethyl ether acetate, diethylene glycol monobutyl ether acetate, diethylene glycol monoethyl ether acetate, ethyl 3-ethoxypropionate, 3-methoxybutyl acetate, 3-methyl-3-methoxybutyl acetate, methyl formate, ethyl formate, butyl formate, propyl formate, ethyl lactate, butyl lactate, and propyl lactate.

Examples of the alcohol-based solvents include alcohols such as methyl alcohol, ethyl alcohol, n-propyl alcohol, isopropyl alcohol, n-butyl alcohol, sec-butyl alcohol, tert-butyl alcohol, isobutyl alcohol, n-hexyl alcohol, n-heptyl alcohol, n-octyl alcohol, and n-decanol; glycol-based solvents such as ethylene glycol, diethylene glycol, and triethylene glycol; and glycol ether-based solvents such as ethylene glycol monomethyl ether, propylene glycol monomethyl ether, ethylene glycol monoethyl ether, propylene glycol monoethyl ether, diethylene glycol monomethyl ether, triethylene glycol monoethyl ether, and methoxymethyl butanol.

Examples of the ether-based solvents include dioxane and tetrahydrofuran in addition to the glycol ether-based solvents.

Examples of the amide-based solvents include N-methyl-2-pyrrolidone, N,N-dimethylacetamide, N,N-dimethylformamide, hexamethylphosphoric triamide, and 1,3-dimethyl-2-imidazolidinone.

Examples of the hydrocarbon-based solvents include aromatic hydrocarbon-based solvents such as toluene and xylene; and aliphatic hydrocarbon-based solvents such as pentane, hexane, octane, and decane. Various solutions and solvents have been listed above, and as the chemical solutions, water may be mixed with the various solutions and solvents.

Examples of the resins include thermoplastic resins and thermosetting resins. Examples of the thermosetting resins include polyethylene, polypropylene, polyvinyl chloride, polystyrene, acrylonitrile-butadiene-styrene, acrylonitrile-styrene, polymethyl methacrylate, polyvinyl alcohol, polyvinylidene chloride, polyethylene terephthalate, engineering plastics, and super engineering plastics. Examples of the thermosetting resins include phenolic resins, urea resins, melamine resins, unsaturated polyesters, epoxy resins, silicone resins, and polyurethane.

For the organic solvent for use in the present embodiment, from the viewpoint of recycling waste as fuel, used or no longer needed organic solvent waste liquids are preferred, and more preferred are resin solutions produced by separation and purification during organic synthesis of resins, organic solvent waste liquids produced when semiconductor elements or liquid crystal display elements are manufactured, and the like. Examples of these organic solvent waste liquids include the various chemical solutions described above and mixed liquids of these chemical solutions.

The mixture of the fuel and the water vapor is ejected into the reduction column 20 from the fuel nozzle 40. The organic solvent ejected into the reduction column 20 functions as a reducing agent. Note that at the beginning of operation, the first switching valve 27 is set such that the connection destination of the carrier gas supply line 26 is the second nitrogen supply line 28. In this case, nitrogen is supplied to the vapor generation unit 24 from the second nitrogen supply line 28 as the carrier gas. The vapor generated in the vapor generation unit 24 is carried by the nitrogen as the carrier gas to the mixer 22, is mixed with the organic solvent as the fuel, and is supplied to the fuel nozzle 40.

The fluidizing gas is supplied to the fluidizing gas chamber 32 from the fluidizing gas supply line 16 via the fluidizing gas introducer 47. The fluidizing gas in the fluidizing gas chamber 32 is ejected into the oxidation column 10 from the fluidizing gas nozzle 44. The fluidizing gas fluidizes the metal particles M inside the oxidation column 10. Note that at the beginning of operation, the second switching valve 17 is set such that the connection destination of the fluidizing gas supply line 16 is the nitrogen supply line 18. Thus, nitrogen is ejected as the fluidizing gas from the fluidizing gas nozzle 44.

In the oxidation column 10, the metal particles M preheated to a reaction temperature react with oxygen in the supplied air to produce the metal oxide particles MO. In this process, the oxidation reaction of metal generates heat, and the metal particles M, the metal oxide particles MO, and the air flowing inside the oxidation column 10 rise in temperature. In this case, the heat generation is caused by the oxidation reaction of metal, and thermal NOx is not produced because no high-temperature parts at 1,500° C. or higher are produced. Note that the metal oxide particles MO may be in the form of being further oxidized. For example, when the metal oxide particles MO are Fe₃O₄, they may be further oxidized, and the metal oxide particles MO may become Fe₂O₃ or the like.

The metal oxide particles MO and the unoxidized metal particles M flow into the reduction column 20 inside the oxidation column 10 and then rise inside the reduction column 20. In the process of rising inside the reduction column 20, the metal oxide particles MO undergo reduction action by the organic solvent to become the metal particles M. A solid component and a gas component rising inside the reduction column 20 are separated into the solid component and the gas component by the solid-gas separation apparatus 50. The gas component rises in the solid-gas separation apparatus 50 and is exhausted from the exhauster 57 at the upper part of the reduction column 20. The solid component, that is, the metal particles M and the remaining metal oxide particles MO are returned into the oxidation column 10 by the solid-gas separation apparatus 50.

Due to the oxidation reaction inside the oxidation column 10, the air supplied to the oxidation column 10 becomes a high-temperature gas, which is discharged from the exhauster 14 at the upper part of the oxidation column 10. Note that metal fragments and the like in the gas discharged from the oxidation column 10 are separated by the solid-gas separator 15 and are returned into the oxidation column 10 when necessary. The discharged gas is either highly concentrated nitrogen containing no oxygen or a mixed gas containing residual oxygen and nitrogen in accordance with the amount of the air supplied to the oxidation column 10. Among the exhaust gases, for example, the nitrogen may be sent to a nitrogen storage tank or the like by a recovery line, not illustrated, and stored.

The gas discharged from the reduction column 20 contains the carbon dioxide produced by the reduction reaction described above and water vapor. The gas discharged from the reduction column 20 is condensed by the gas-liquid separation apparatus 58, through which cooling water is circulated, and is separated into water and highly concentrated (90% or more, suitably 95% or more) carbon dioxide. The carbon dioxide obtained in the gas-liquid separation apparatus 58 is sent to the carbon dioxide supply line 70. In the carbon dioxide supply line 70, the carbon dioxide flows through the recovery line 71, and its flow is measured by the flow measurement device 72. The carbon dioxide having passed through the flow measurement device 72 flows along the recovery line 71 to the regulating valve 73.

The regulating valve 73 is switched among the modes in accordance with a measurement result by the flow measurement device 72. The regulating valve 73 is, for example, set to the first mode in an initial state. In other words, in the initial state, the recovery line 71 and the first line 74 are caused to communicate with each other. Thus, the carbon dioxide flows from the recovery line 71 to the first line 74. The regulating valve 73 switches from the first mode to the second mode when the flow of the carbon dioxide per unit time in the recovery line 71 exceeds a first threshold. In this case, the recovery line 71 and the second line 76 are caused to communicate with each other. In the reduction column 20, the amount of the metal oxide particles MO of the reduction reaction increases, thereby increasing the amount of the carbon dioxide produced. In such a case, the regulating valve 73 switches from the first mode to the second mode in order to avoid the carbon dioxide from being excessively sent via the first line 74. Thus, the carbon dioxide is sent from the recovery line 71 to the second line 76 and is stored in the second tank 77 via the second line 76.

The regulating valve 73 switches from the first mode to the third mode when the flow of the carbon dioxide per unit time in the recovery line 71 is less than a second threshold. In this case, the first line 74 and the second line 76 are connected to each other. In the reduction column 20, when the amount of the metal oxide particles MO of the reduction reaction decreases, the amount of the carbon dioxide produced decreases. In such a case, the regulating valve 73 switches from the first mode to the third mode in order to avoid the amount of the carbon dioxide supplied from becoming insufficient via the first line 74. Thus, the carbon dioxide stored in the second tank 77 is sent to the first line 74 via the second line 76 and the regulating valve 73.

Note that the regulating valve 73 maintains the first mode when the flow of the carbon dioxide per unit time in the recovery line 71 is the second threshold or more and less than the first threshold. The carbon dioxide sent from the recovery line 71 to the first line 74 or the carbon dioxide sent from the second line 76 to the first line 74 is sent to the first tank 75 via the first connection line 78 and is stored in the first tank 75. With the carbon dioxide stored in the first tank 75, even when a required amount of the carbon dioxide fluctuates downstream of the first tank 75, the fluctuations can be coped with by changing the amount of the carbon dioxide sent from the first tank 75.

When the carrier gas supply line 26 and the second connection line 79 are connected to each other by the first switching valve 27, the connection between the carrier gas supply line 26 and the second nitrogen supply line 28 is cut off, and the supply of the nitrogen to the carrier gas supply line 26 is stopped. Meanwhile, the carbon dioxide stored in the first tank 75 flows to the carrier gas supply line 26 from the second connection line 79 via the first switching valve 27 and is supplied to the vapor generation unit 24. Thus, the carrier gas to carry the vapor is switched from the nitrogen to the carbon dioxide. The vapor generated in the vapor generation unit 24 is sent to the vapor supply line 23 together with the carbon dioxide. Thus, the carbon dioxide is supplied to the vapor generation unit 24 as the carrier gas instead of the nitrogen, and thereby the consumption of the nitrogen can be reduced.

When the fluidizing gas supply line 16 and the third connection line 80 are connected to each other by the second switching valve 17, the connection between the fluidizing gas supply line 16 and the nitrogen supply line 18 is cut off, and the supply of the nitrogen to the fluidizing gas supply line 16 is stopped. Meanwhile, the carbon dioxide stored in first tank 75 flows through the third connection line 80 and flows through the fluidizing gas supply line 16 via the second switching valve 17. Thus, the fluidizing gas supplied to the fluidizing gas chamber 32 is switched from the nitrogen to the carbon dioxide. The carbon dioxide in the fluidizing gas chamber 32 is supplied to the oxidation column 10 from the fluidizing gas nozzle 44 and is used to fluidize the metal particles M and the metal oxide particles MO. Thus, the carbon dioxide is used instead of the nitrogen as the fluidizing gas, and thereby the amount of the nitrogen used can be reduced.

### Method for Utilizing Carbon Dioxide

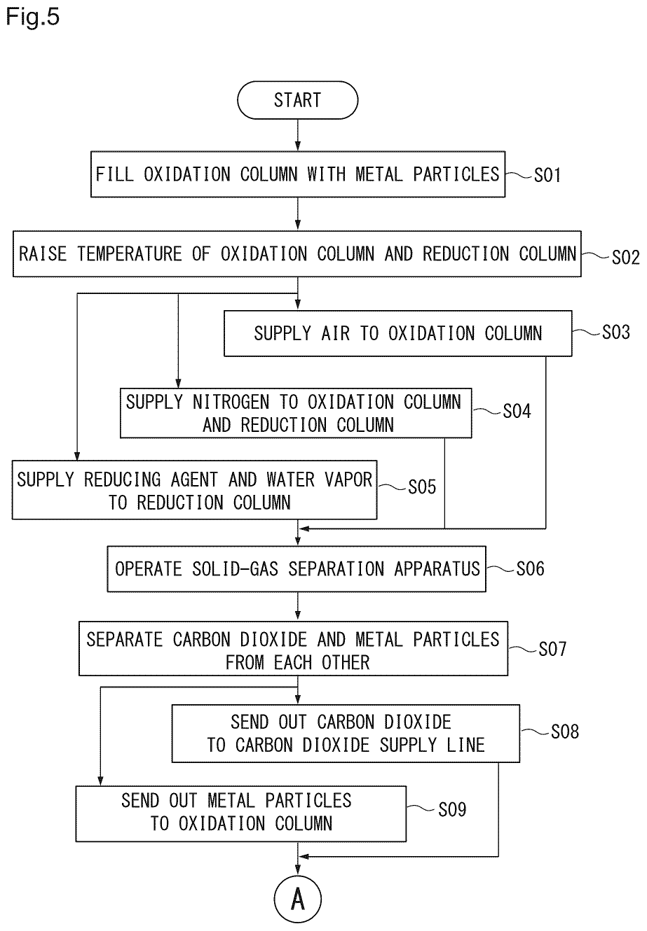

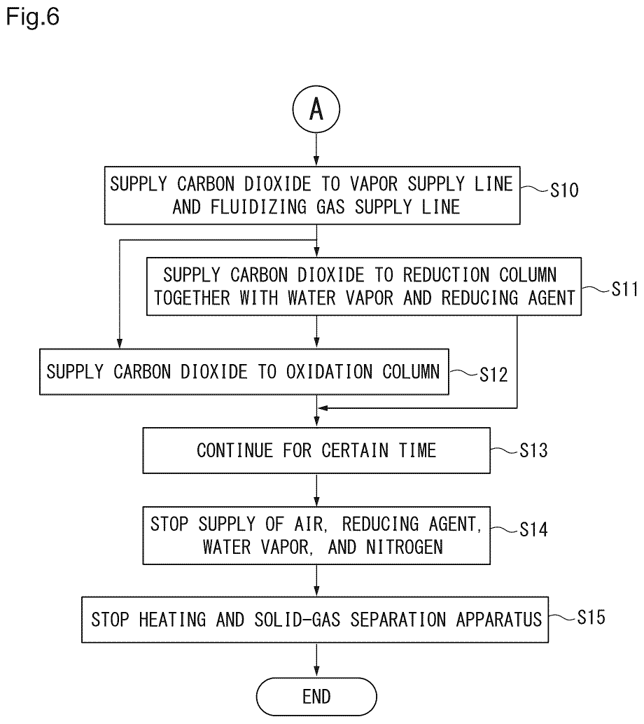

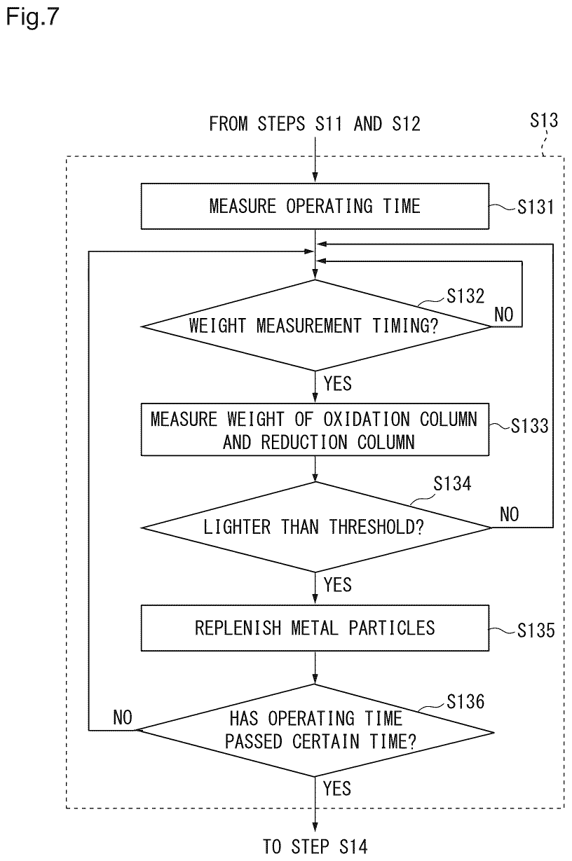

The following describes a method for utilizing carbon dioxide according to the first embodiment. The method for utilizing carbon dioxide according to the first embodiment can be performed by the chemical loop reaction system 100 of the first embodiment described above. FIG. 5 is a flowchart of an example of the method for utilizing carbon dioxide according to the first embodiment. FIG. 6 is a flowchart of the example of the method for utilizing carbon dioxide according to the first embodiment following FIG. 5. FIG. 7 is a flowchart illustrating part of the flowchart in FIG. 6 in detail.

The operations illustrated in the flowcharts in FIG. 5 to FIG. 7 may be controlled by the controller C or performed by operations by an operator or the like. The controller C comprehensively controls the operations in the chemical loop reaction system 100 described above. As illustrated in FIG. 5, first, the oxidation column 10 is filled with the metal particles M (Step S01). In Step S01, the oxidation column 10 is provided with a material feeding port, not illustrated, and a certain amount of the metal particles M are fed from the material feeding port and are filled in the oxidation column 10. Feeding of the metal particles M may be performed by a supply apparatus or the like or performed by the operator. When the feeding of the metal particles M is performed by the supply apparatus or the like, the feeding amount may be set in advance, and the feeding may be performed automatically under the control of the controller C.

Subsequently, the temperature of the oxidation column 10 and the reduction column 20 is raised (Step S02). In Step S02, the oxidation column 10 and the reduction column 20 are heated by an electric heater or the like, not illustrated. Subsequently, air is supplied to the oxidation column 10 (Step S03). In Step S03, the air is supplied to the oxidation column 10 via the air nozzle 42. The amount of the air to be supplied is set as appropriate according to the amount of the metal particles M filled. Nitrogen is supplied to the oxidation column 10 and the reduction column 20 (Step S04). In Step S04, the nitrogen is supplied to the oxidation column 10 via the fluidizing gas nozzle 44.

Fuel as a reducing agent and water vapor are supplied to the reduction column 20 (Step S05). In Step S05, the fuel and the water vapor mixed in the mixer 22 are supplied to the reduction column 20 from the fuel nozzle 40. Note that nitrogen is used as the carrier gas for the water vapor. Note that Step S03 to Step S05 may be performed in sequence or performed simultaneously. Subsequently, the solid-gas separation apparatus 50 is operated (Step S06). Subsequently, carbon dioxide and the metal particles M are separated from each other by the solid-gas separation apparatus 50 (Step S07). In Step S07, the solid-gas separation apparatus 50 separates the carbon dioxide as a gas component and the metal particles M as a solid component from each other.

Subsequently, in the solid-gas separation apparatus 50, the carbon dioxide is sent out to the carbon dioxide supply line 70 (Step S08). In Step S08, the carbon dioxide is sent to the carbon dioxide supply line 70 from the solid-gas separation apparatus 50. In the solid-gas separation apparatus 50, the metal particles M are sent out to the oxidation column 10 (Step S09). In Step S09, the metal particles M are returned to the oxidation column 10 from the solid-gas separation apparatus 50. Note that Step S08 and Step S09 may be performed in sequence or performed simultaneously.

Subsequently, as illustrated in FIG. 6, the carbon dioxide is supplied to the vapor supply line 23 and the fluidizing gas supply line 16 (Step S10). In Step S10, the carbon dioxide is sent to the vapor supply line 23 and the fluidizing gas supply line 16 via the recovery line 71 and the first line 74 of the carbon dioxide supply line 70, respectively. Subsequently, the carbon dioxide is supplied to the reduction column 20 together with the water vapor and the fuel (the reducing agent) (Step S11). In Step S10 described above, the water vapor is carried by the carbon dioxide in the vapor supply line 23. In the mixer 22, the fuel is mixed with the water vapor and the carbon dioxide. Thus, in Step S11, the carbon dioxide is supplied to the reduction column 20 together with the water vapor and the fuel.

The carbon dioxide is supplied to the oxidation column 10 (Step S12). In Step S12, the carbon dioxide is supplied to the oxidation column 10 from the carbon dioxide supply line 70 via the fluidizing gas supply line 16. By adjusting the second switching valve 17, the nitrogen sent by the nitrogen supply line 18 and the carbon dioxide sent by the carbon dioxide supply line 70 may be mixed together, and this mixed gas may be supplied to the oxidation column 10 via the fluidizing gas supply line 16. Note that Step S11 and Step S12 may be performed simultaneously or performed at different times by shifting the operation timing of the first switching valve 27 and the second switching valve 17.

Subsequently, the operating state of the chemical loop reaction system 100 is continued for a certain time (Step S13). In step S13, the flowchart illustrated in FIG. 7 is performed. Note that each step in the flowchart illustrated in FIG. 7 may be performed by the controller C or performed by an operation by the operator. As illustrated in FIG. 7, an operating time of the chemical loop reaction system 100 is measured (Step S131). In Step S131, the operating time is measured by, for example, a timer or the like included in the controller C.

Next, it is determined whether it is weight measurement timing (Step S132). The controller C determines whether the operating time measured in Step S131, for example, has passed a preset certain time. Note that, for example, the amount (ratio) of the metal particle M decreasing over time may be acquired in advance by test operation or the like, and the certain time may be set to the time when the amount of the metal particle M is expected to decrease. If it is not the weight measurement timing (NO in Step S132), Step S132 is repeatedly performed.

If it is the weight measurement timing (YES in Step S132), the weight of the oxidation column 10 and the reduction column 20 is measured (Step S133). In Step S133, the controller C measures the weight of the oxidation column 10 and the reduction column 20 on the basis of the output of the load cell 91 (refer to FIG. 2). Subsequently, it is determined whether the weight of the oxidation column 10 and the reduction column 20 is lighter than a threshold (Step S134). In Step S134, the controller C determines whether the weight of the oxidation column 10 and the reduction column 20 is lighter than the preset threshold.

If the weight of the oxidation column 10 and the reduction column 20 is heavier than the threshold (NO in Step S134), the process returns to Step S132. If the weight of the oxidation column 10 and the reduction column 20 is lighter than the threshold (YES in Step S134), the metal particles M are replenished (Step S135). When the amount of the metal particles M decreases over time as described above, the amount of the fuel used as the reducing agent consumed decreases, and the amount of the carbon dioxide produced from the reduction column 20 also decreases. By replenishing the metal particles M at the timing when the amount of the metal particles M decreases and the weight of the oxidation column 10 and the reduction column 20 becomes lighter than the threshold, the amount of the fuel consumed can be increased, and the amount of the carbon dioxide produced can be increased.

Subsequently, it is determined whether the operating time of the chemical loop reaction system 100 has passed a certain time (Step S136). In step S136, the controller C determines whether the operating time of the chemical loop reaction system 100 has passed the certain time using a timer or the like. If the operating time has not passed the certain time (NO in Step S136), the process returns to Step S132. If the operating time has passed the certain time (YES in Step S136), Step S14 illustrated in FIG. 6 is performed. As illustrated in FIG. 6, the controller C stops the supply of the air, the fuel (the reducing agent), the water vapor, and the nitrogen (Step S14). Subsequently, the controller C stops the heating and the solid-gas separation apparatus 50 (Step S15). By Step S15, the chemical loop reaction system 100 stops operation, and the series of processing described above ends.

Thus, according to the chemical loop reaction system 100 and the method for utilizing carbon dioxide of the first embodiment, the carbon dioxide produced in reduction column 20 is supplied to the reduction column 20 and the oxidation column 10, and thus part or the whole of the nitrogen to be supplied to the oxidation column 10 and the reduction column 20 can be replaced with the carbon dioxide, and the amount of the nitrogen used can be reduced. Consequently, operational efficiency can be improved in the chemical loop reaction system. In addition, the produced carbon dioxide is utilized in the chemical loop reaction system 100, and thus the carbon dioxide can be used effectively, and the amount of the carbon dioxide released into the atmosphere can be reduced.

### Second Embodiment

### Chemical Loop Reaction System

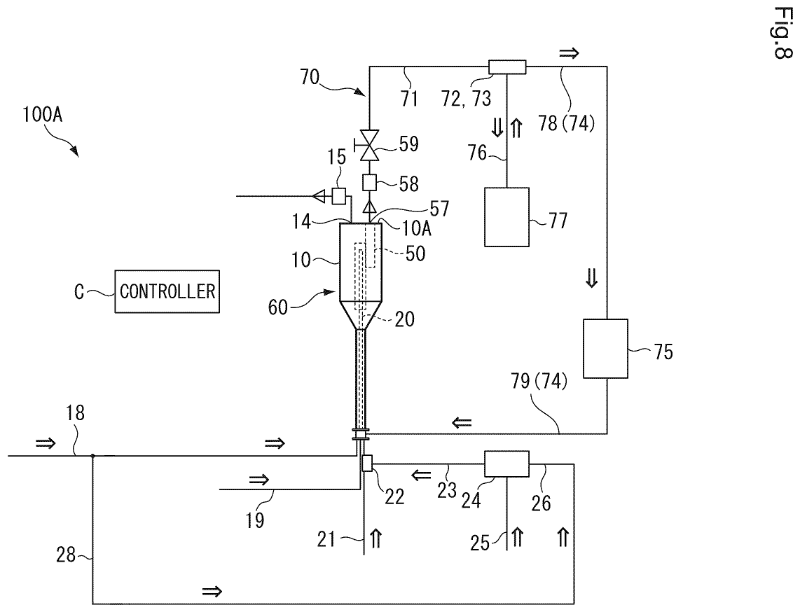

The following describes a chemical loop reaction system 100A according to a second embodiment. FIG. 8 is a diagram of an example of the chemical loop reaction system 100A according to the second embodiment. Note that in FIG. 8, the same components as those of the first embodiment described above are denoted by the same symbols, and descriptions thereof are omitted or simplified. As illustrated in FIG. 8, the chemical loop reaction system 100A differs from that of the first embodiment in that the first line 74 of the carbon dioxide supply line 70 is directly connected to the oxidation column 10 or the reduction column 20. That is, the carbon dioxide is sent to the oxidation column 10 or the reduction column 20 without the line supplying the fuel or the fluidizing gas (the nitrogen).

In the chemical loop reaction system 100A, the second connection line 79 of the carbon dioxide supply line 70 is connected to, for example, the fluidizing gas chamber 32. In this case, the carbon dioxide sent by the carbon dioxide supply line 70 is supplied to the oxidation column 10 from the fluidizing gas chamber 32 (refer to FIG. 2) via the fluidizing gas nozzle 44 (refer to FIG. 2) to be used to fluidize the metal particles M. Note that in the fluidizing gas chamber 32, the carbon dioxide may be supplied to the oxidation column 10 mixed with the nitrogen sent via the fluidizing gas supply line 16.

Note that the carbon dioxide sent by the carbon dioxide supply line 70 may be, for example, supplied to the oxidation column 10 via a dedicated supply nozzle or supply pipe provided separately. The carbon dioxide sent by the carbon dioxide supply line 70 may be supplied to the reduction column 20. When the carbon dioxide is supplied to the reduction column 20, for example, a dedicated supply nozzle, supply pipe, or the like may be provided alongside the fuel nozzle 40 and the fuel supply pipe 41, and the carbon dioxide may be supplied via the supply nozzle or the supply pipe.

### Method for Utilizing Carbon Dioxide

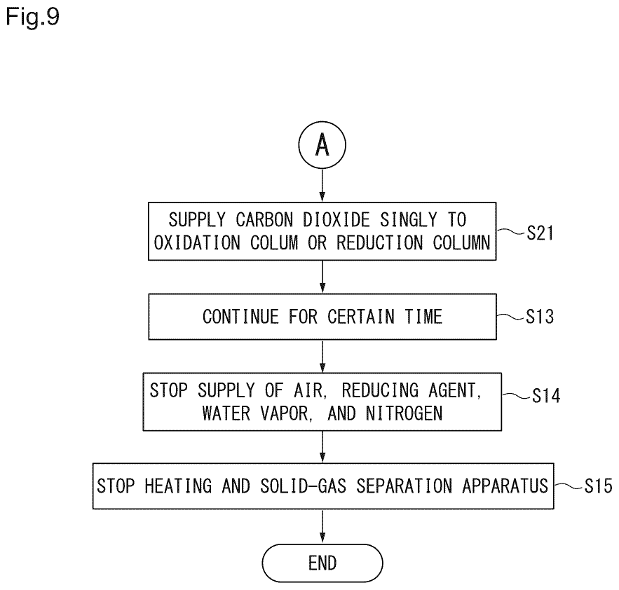

The following describes a method for utilizing carbon dioxide according to the second embodiment. The method for utilizing carbon dioxide according to the second embodiment can be performed by the chemical loop reaction system 100A of the second embodiment described above. FIG. 9 is a flowchart of an example of the method for utilizing carbon dioxide according to the second embodiment. In FIG. 9, the same steps as those of the first embodiment described above are denoted by the same symbols, and descriptions thereof are omitted or simplified. The operations illustrated in the flowchart in FIG. 9 may be controlled by the controller C or performed by operations by the operator or the like.

After Step S08 and Step S09 illustrated in FIG. 5, as illustrated in FIG. 9, the carbon dioxide is singly supplied to the oxidation column 10 or the reduction column 20 (Step S21). In Step S21, the carbon dioxide sent by the carbon dioxide supply line 70 is supplied to the oxidation column 10 or the reduction column 20 via a dedicated supply nozzle or the like. Note that Step S13 to Step S15 after Step S21 are the same as those of the first embodiment, and descriptions thereof are omitted.

Thus, according to the second embodiment, as in the first embodiment described above, the carbon dioxide produced in the reduction column 20 is supplied to the reduction column 20 or the oxidation column 10, and thus the amount of the nitrogen used can be reduced. In addition, the first switching valve 27, the second switching valve 17, and the third connection line are no longer needed for the chemical loop reaction system 100 of the first embodiment, and the system can be simplified. In addition, the produced carbon dioxide is utilized in the chemical loop reaction system 100A, and thus the carbon dioxide can be utilized effectively.

### Third Embodiment

### Chemical Loop Reaction System

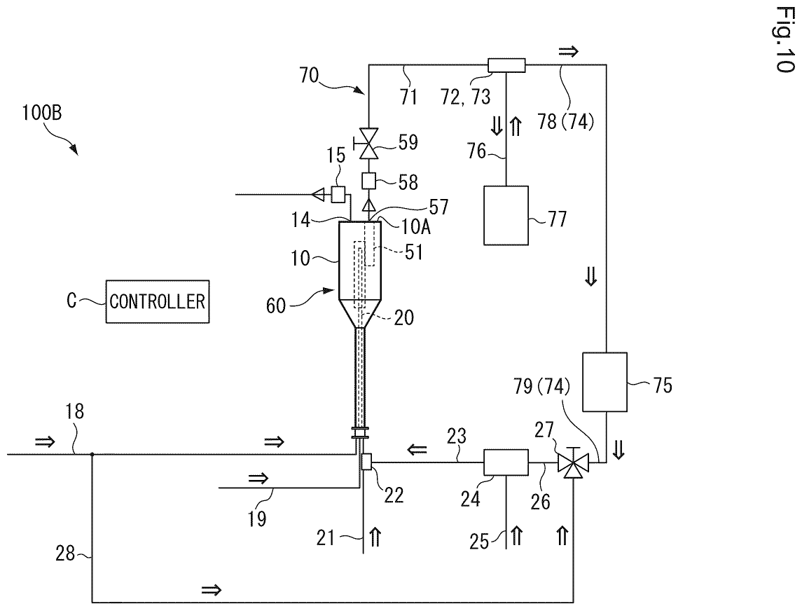

The following describes a chemical loop reaction system 100B according to a third embodiment. FIG. 10 is a diagram of an example of the chemical loop reaction system 100B according to the third embodiment. Note that in FIG. 10, the same components as those of the first embodiment described above are denoted by the same symbols, and descriptions thereof are omitted or simplified. As illustrated in FIG. 10, the chemical loop reaction system 100B differs from that of the first embodiment in that the first line 74 of the carbon dioxide supply line 70 is connected only to the carrier gas supply line 26 via the first switching valve 27. That is, the carbon dioxide is used as the carrier gas for the water vapor in the vapor supply line 23 and is supplied to the reduction column 20 together with the fuel and the water vapor via the fuel supply line 21.

In the chemical loop reaction system 100B, as in the first embodiment, the second connection line 79 of the first line 74 is connected to the first switching valve 27. Thus, by switching the first switching valve 27, it is possible to switch between the nitrogen and the carbon dioxide as the carrier gas for the water vapor produced in the vapor generation unit 24.

### Method for Utilizing Carbon Dioxide

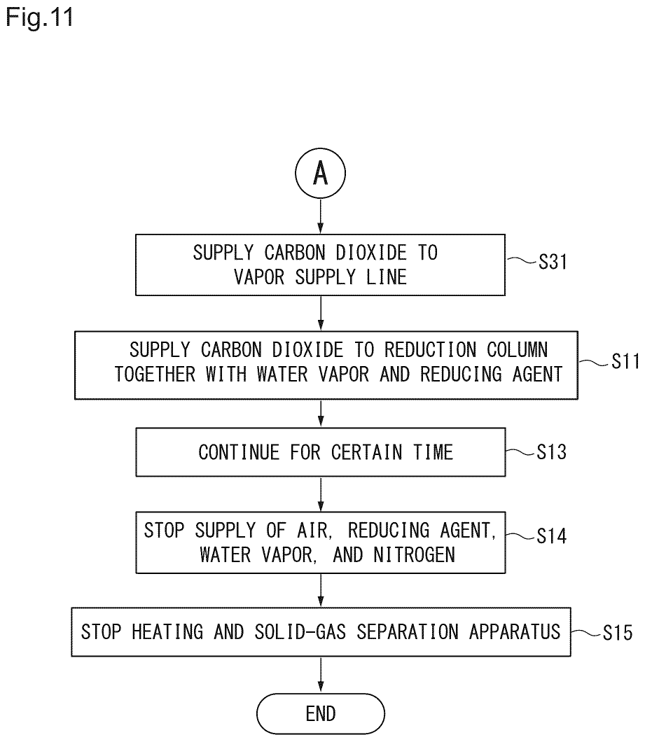

The following describes a method for utilizing carbon dioxide according to the third embodiment. The method for utilizing carbon dioxide according to the third embodiment can be performed by the chemical loop reaction system 100B of the third embodiment described above. FIG. 11 is a flowchart of an example of the method for utilizing carbon dioxide according to the third embodiment. In FIG. 11, the same steps as those of the first embodiment described above are denoted by the same symbols, and descriptions thereof are omitted or simplified. The operations illustrated in the flowchart in FIG. 11 may be controlled by the controller C or performed by operations by the operator or the like.

After Step S08 and Step S09 illustrated in FIG. 5, as illustrated in FIG. 11, the carbon dioxide is supplied to the vapor supply line 23 (Step S31). In Step S31, the first switching valve 27 causes the second connection line 79 and the carrier gas supply line 26 to communicate with each other. Consequently, the carbon dioxide sent by the carbon dioxide supply line 70 is supplied to the vapor supply line 23 as the carrier gas for the water vapor and is supplied to the reduction column 20 together with the fuel. Note that Steps S11, S13, S14, and S15 after Step S31 are the same as those of the first embodiment, and descriptions thereof are omitted.

Thus, according to the third embodiment, as in the first embodiment described above, the carbon dioxide produced in the reduction column 20 is supplied to the reduction column 20, and thus the amount of the nitrogen as the carrier gas for the water vapor used can be reduced. In addition, the second switching valve 17 and the third connection line are no longer needed for the chemical loop reaction system 100 of the first embodiment, and the system can be simplified. In addition, the produced carbon dioxide is utilized in the chemical loop reaction system 100B, and thus the carbon dioxide can be utilized effectively.

### Fourth Embodiment

### Chemical Loop Reaction System

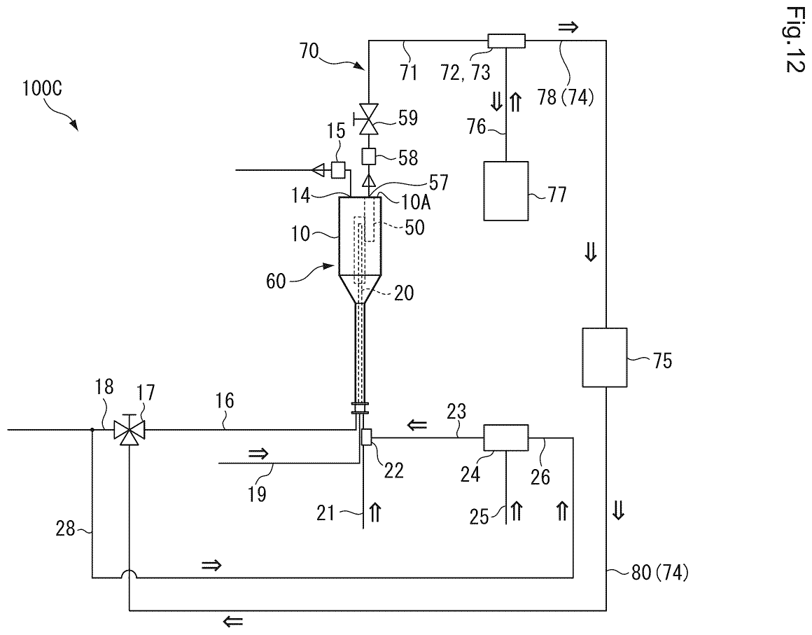

The following describes a chemical loop reaction system 100C according to a fourth embodiment. FIG. 12 is a diagram of an example of the chemical loop reaction system 100C according to the fourth embodiment. Note that in FIG. 12, the same components as those of the first embodiment described above are denoted by the same symbols, and descriptions thereof are omitted or simplified. As illustrated in FIG. 12, the chemical loop reaction system 100C differs from that of the first embodiment in that the first line 74 of the carbon dioxide supply line 70 is connected only to the fluidizing gas supply line 16 via the second switching valve 17. That is, the carbon dioxide is supplied to the oxidation column 10 via the fluidizing gas supply line 16 as the fluidizing gas.

In the chemical loop reaction system 100C, as in the first embodiment, the third connection line 80 of the first line 74 is connected to the second switching valve 17. Thus, by switching the second switching valve 17, it is possible to switch between the nitrogen and the carbon dioxide as the fluidizing gas.

### Method for Utilizing Carbon Dioxide

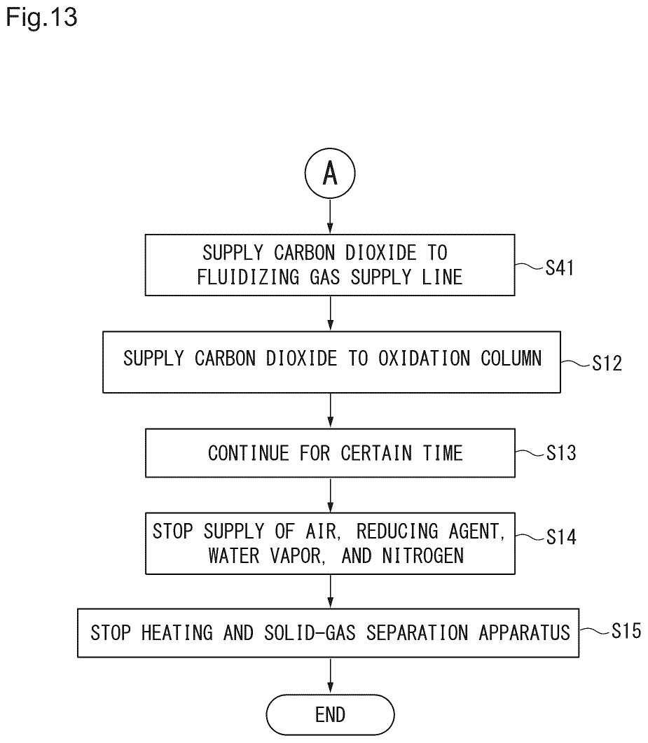

The following describes a method for utilizing carbon dioxide according to the fourth embodiment. The method for utilizing carbon dioxide according to the fourth embodiment can be performed by the chemical loop reaction system 100C of the fourth embodiment described above. FIG. 13 is a flowchart of an example of the method for utilizing carbon dioxide according to the fourth embodiment. In FIG. 13, the same steps as those of the first embodiment described above are denoted by the same symbols, and descriptions thereof are omitted or simplified. The operations illustrated in the flowchart in FIG. 13 may be controlled by the controller C or performed by operations by the operator or the like.

After Step S08 and Step S09 illustrated in FIG. 5, as illustrated in FIG. 13, the carbon dioxide is supplied to the fluidizing gas supply line 16 (Step S41). In Step S41, the second switching valve 17 causes the third connection line 80 and the fluidizing gas supply line 16 to communicate with each other. Consequently, the carbon dioxide sent by the carbon dioxide supply line 70 is supplied to the fluidizing gas supply line 16 and is supplied to the oxidation column 10 as the fluidizing gas. Step S12 to Step S15 after Step S41 are the same as those of the first embodiment, and descriptions thereof are omitted.

Thus, according to the fourth embodiment, as in the first embodiment described above, the carbon dioxide produced in the reduction column 20 is supplied to the oxidation column 10, and thus the amount of the nitrogen as the fluidizing gas used can be reduced. In addition, the first switching valve 27 and the second connection line 79 are no longer needed for the chemical loop reaction system 100 of the first embodiment, and the system can be simplified. In addition, the produced carbon dioxide is utilized in the chemical loop reaction system 100C, and thus the carbon dioxide can be utilized effectively.

### Fifth Embodiment

### Chemical Loop Reaction System

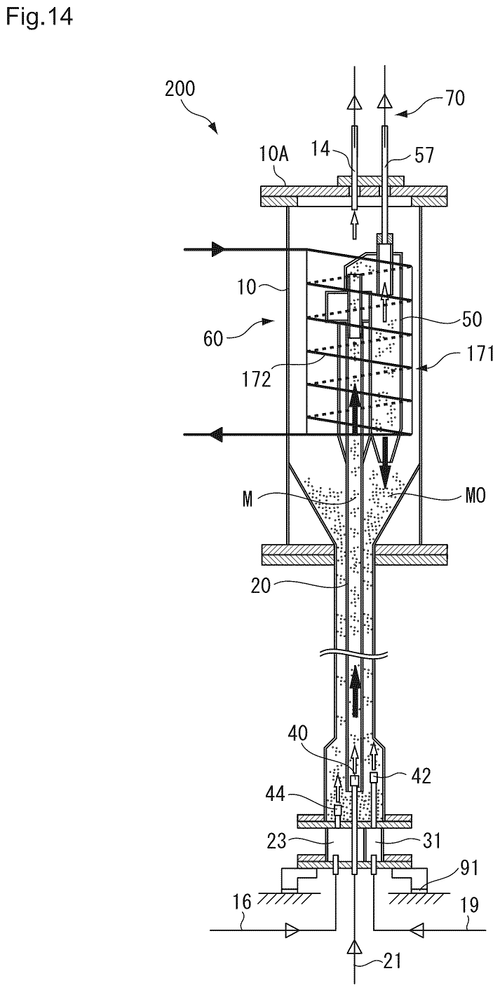

The following describes a chemical loop reaction system 200 according to a fifth embodiment. FIG. 14 is a diagram of an example of the chemical loop reaction system 200 according to the fifth embodiment. Note that in FIG. 14, the part mainly of the oxidation column 10 and the reduction column 20 in the chemical loop reaction system 200 is illustrated, and the other components are omitted because they are the same as those of the first embodiment to the fourth embodiment described above. In FIG. 14, the same components as those of the first embodiment described above are denoted by the same symbols, and descriptions thereof are omitted or simplified.

As illustrated in FIG. 14, the chemical loop reaction system 200 includes a heat recovery unit 171. The heat recovery unit 171 is disposed with piping 172 spirally wound around the reduction column 20 inside the oxidation column 10. The piping 172 is formed of a material that can transfer heat to the inside. Through the piping 172, liquid as a heat medium is flown with the flow indicated by the arrows. For this liquid, for example, water may be used, or a liquid with a higher boiling point than water may be used. Note that the liquid may be in the form of being circulated through the piping 172 with the flow indicated by the arrows.

The liquid flowing inside the piping 172 receives heat generated in the oxidation column 10 to be heated in the spiral part, thereby enabling heat recovery. The recovered heat may be, for example, used as a heat source for the vapor generation unit 24 (refer to FIG. 1) or used as a heat source to heat the fuel supplied by the fuel supply line 21. In addition, it may also be used as a heat source for other apparatuses. Note that when water is used as the liquid, it can be heated in the spiral part of the piping 172 to become water vapor. Thus, the heat recovery unit 171 can be used instead of the vapor generation unit 24 described above.

Thus, according to the fifth embodiment, the heat generated along with the operation of the chemical loop reaction system 200 is recovered by the heat recovery unit 171, and thus the recovered heat can be used as, for example, various heat sources such as a heat source for the vapor generation unit 24 to reduce system operational costs. In addition, in the form in which water vapor is generated by the heat recovery unit 171, by replacing the vapor generation unit 24 with the heat recovery unit 171, the space to dispose the vapor generation unit 24 can be reduced, and the system can be downsized. It can be simplified.

### Sixth Embodiment

### Chemical Loop Reaction System

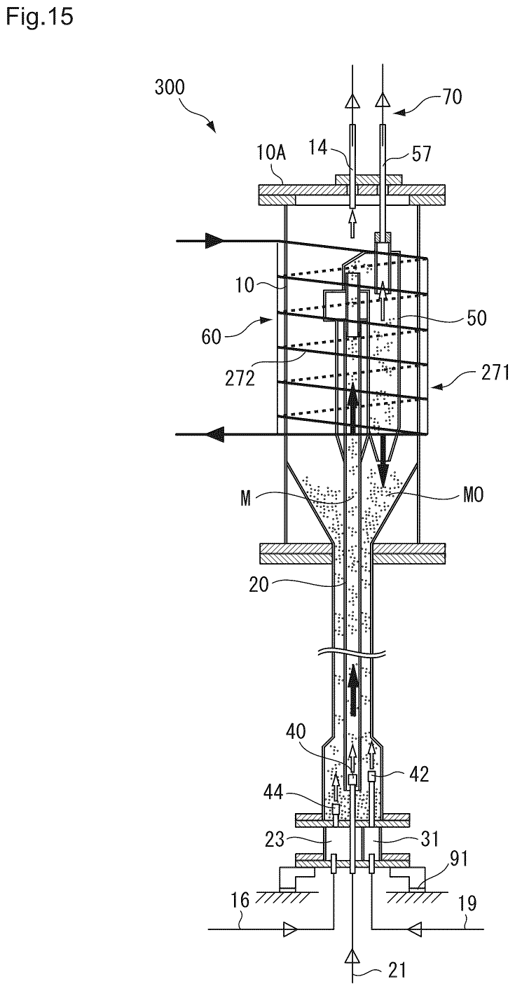

The following describes a chemical loop reaction system 300 according to a sixth embodiment. FIG. 15 is a diagram of an example of the chemical loop reaction system 300 according to the sixth embodiment. Note that in FIG. 15, the part mainly of the oxidation column 10 and the reduction column 20 in the chemical loop reaction system 300 is illustrated, and the other components are omitted because they are the same as those of the first embodiment to the fourth embodiment described above. In FIG. 15, the same components as those of the first embodiment described above are denoted by the same symbols, and descriptions thereof are omitted or simplified.

As illustrated in FIG. 15, the chemical loop reaction system 300 includes a heat recovery unit 271. The heat recovery unit 271 is disposed with piping 272 spirally wound around the oxidation column 10. The piping 272 is formed of a material that can transfer heat to the inside. Through the piping 272, liquid as a heat medium is flown with the flow indicated by the arrows. For this liquid, for example, water may be used, or a liquid with a higher boiling point than water may be used. Note that the liquid may be in the form of being circulated through the piping 272 with the flow indicated by the arrows.

The liquid flowing inside the piping 272 receives heat generated in the oxidation column 10 to be heated in the spiral part, thereby enabling heat recovery. The recovered heat may be, for example, used as a heat source for the vapor generation unit 24 (refer to FIG. 1) or used as a heat source to heat the fuel supplied by the fuel supply line 21. In addition, it may also be used as a heat source for other apparatuses. Note that when water is used as the liquid, it can be heated in the spiral part of the piping 272 to become water vapor. Thus, the heat recovery unit 271 can be used instead of the vapor generation unit 24 described above.

Thus, according to the sixth embodiment, as in the fifth embodiment described above, the heat generated along with the operation of the chemical loop reaction system 300 is recovered by the heat recovery unit 271, and thus the recovered heat can be used as various heat sources to reduce system operational costs. In addition, in the form in which water vapor is generated by the heat recovery unit 271, by replacing the vapor generation unit 24 with the heat recovery unit 271, the space to dispose the vapor generation unit 24 can be reduced, and the system can be downsized.

Although the embodiments have been described above, the technical scope of the present invention is not limited to the embodiments described above. It is clear to those skilled in the art that various changes or improvements can be added to the embodiments described above. Forms with such changes or improvements added are also included in the technical scope of the present invention. One or more of the requirements described in the embodiments described above may be omitted. The requirements described in the embodiments described above can be combined with each other as appropriate. The order of execution of the operations shown in the embodiments can be implemented in any order so long as the results of the previous operation are not used in the subsequent operation. Even if the operations in the embodiments described above are described using “first”, “next”, “subsequently”, and the like for the sake of convenience, it is not essential that they be performed in this order.

The embodiments described above describe a form in which the reduction column 20 is disposed inside the oxidation column 10 as an example, but this form is not limiting. For example, the oxidation column 10 may be disposed inside the reduction column 20. The oxidation column 10 and the reduction column 20 may be disposed separately, and a flow path moving the metal oxide particles MO in the oxidation column 10 to the reduction column 20 and a flow path moving the metal particles M in the reduction column 20 to the oxidation column 10 may be provided.

To the extent permitted by law, the details of Japanese Patent Application No. 2022-090952, a Japanese patent application, and all references cited in the embodiments described above and the like are hereby incorporated herein by reference and made part of the description of the text.

### DESCRIPTION OF REFERENCE SIGNS

M: metal particles
MO: metal oxide particles
10: oxidation column
16: fluidizing gas supply line
17: second switching valve
18: nitrogen supply line
19: air supply line
20: reduction column
21: fuel supply line (reducing agent supply line)
23: vapor supply line
24: vapor generation unit
25: water supply line
26: carrier gas supply line
27: first switching valve
28: nitrogen supply line
50: solid-gas separation apparatus
60: circulator
70: carbon dioxide supply line
71: recovery line
74: first line
75: first tank
76: second line
77: second tank
100, 100A, 100B, 100C, 200, 300: chemical loop reaction system

1. A chemical loop reaction system comprising:
an oxidation column to oxidize metal particles into metal oxide particles;
a reduction column to react the metal oxide particles with a reducing agent to reduce the metal oxide particles into the metal particles while producing carbon dioxide; and
a circulator that circulates the metal particles and the metal oxide particles between the reduction column and the oxidation column,
the chemical loop reaction system including a carbon dioxide supply line that supplies the carbon dioxide produced in the reduction column to at least one of the reduction column and the oxidation column.

2. The chemical loop reaction system according to claim 1, wherein the reducing agent is an organic solvent.

3. The chemical loop reaction system according to claim 2, wherein the organic solvent contains a powdery or granular resin.

4. The chemical loop reaction system according to claim 1, wherein the carbon dioxide supply line supplies the carbon dioxide from a lower part of at least one of the reduction column and the oxidation column.

5. The chemical loop reaction system according to claim 1, wherein
the carbon dioxide supply line includes a first tank capable of storing carbon dioxide, and
the carbon dioxide is supplied to at least one of the reduction column and the oxidation column via the first tank.

6. The chemical loop reaction system according to claim 1, comprising a reducing agent supply line that supplies the reducing agent to the reduction column, wherein
the carbon dioxide supply line is connected to the reducing agent supply line.

7. The chemical loop reaction system according to claim 6, comprising:
a vapor generation unit that produces vapor; and
a vapor supply line that supplies the vapor produced in the vapor generation unit to the reducing agent supply line, wherein
the carbon dioxide supply line is connected to the vapor generation unit to supply the carbon dioxide together with the vapor to the reducing agent supply line via the vapor supply line.

8. The chemical loop reaction system according to claim 1, comprising a nitrogen supply line that supplies nitrogen to at least one of the reduction column and the oxidation column, wherein
the carbon dioxide supply line is connected to the nitrogen supply line.

9. The chemical loop reaction system according to claim 1, wherein
the carbon dioxide supply line includes:
a flow measurement device that measures a flow of the carbon dioxide;
a recovery line connected to the reduction column;
a regulating valve provided in the recovery line;
a first line that supplies the carbon dioxide to at least one of the reduction column and the oxidation column, downstream of the regulating valve;
a second line provided separately from the first line, downstream of the regulating valve; and
a second tank connected to the second line and capable of storing carbon dioxide, and
the regulating valve is capable of switching to any of a first mode causing the recovery line and the first line to communicate with each other, a second mode causing the recovery line and the second line to communicate with each other, and a third mode causing the first line and the second line to communicate with each other.

10. The chemical loop reaction system according to claim 9, wherein the regulating valve switches to any of the first mode, the second mode, and the third mode in accordance with a measurement result by the flow measurement device.

11. The chemical loop reaction system according to claim 10, wherein the regulating valve switches from the first mode to the second mode when the flow of the carbon dioxide per unit time in the recovery line exceeds a first threshold.

12. The chemical loop reaction system according to claim 10, wherein the regulating valve switches from the first mode to the third mode when the flow of the carbon dioxide per unit time in the recovery line is less than a second threshold.

13. A method for utilizing carbon dioxide produced in a reduction column, in a chemical loop reaction system including an oxidation column to oxidize metal particles into metal oxide particles, the reduction column to react the metal oxide particles with a reducing agent to reduce the metal oxide particles into the metal particles while producing carbon dioxide, and a circulator that circulates the metal particles and the metal oxide particles between the reduction column and the oxidation column, the method comprising supplying the carbon dioxide produced in the reduction column to at least one of the reduction column and the oxidation column to fluidize the metal particles and the metal oxide particles.
